(19) United States
(12) Patent Application Publication
(10) Pub. No.: US 2012/0161557 A1
(43) Pub. Date: Jun. 28, 2012

(54) SUPERCONDUCTING ELECTRIC MOTOR

(75) Inventors: Ryoji MIZUTANI, Nagoya-shi (JP); Yoshimasa OHASHI, Kariya-shi (JP); Nobuo OKUMURA, Toyota-shi (JP); Kenji ISHIDA, Nagoya-shi (JP)

(73) Assignees: AISIN SEIKI KABUSHIKI KAISHA, Kariya-shi (JP); TOYOTA JIDOSHA KABUSHIKI KAISHA, Toyota-shi (JP)

(21) Appl. No.: 13/328,285

(22) Filed: Dec. 16, 2011

(30) Foreign Application Priority Data
Dec. 28, 2010 (JP) 2010-292776

(51) Int. Cl. H02K 1/20

(52) U.S. Cl. 310/64

(57) ABSTRACT

A superconducting electric motor includes: a rotor that is rotatably arranged; and a stator. The stator has a plurality of teeth provided on one radial end portion of a stator core and slots, each of which is provided between two of the plurality of teeth, adjacent in a circumferential direction of the stator. Coils are respectively wound around the teeth. The superconducting electric motor further includes a refrigerator that has a narrow tube that flows low-temperature refrigerant inside. At least part of the narrow tube is arranged between two of the coils, adjacent in the circumferential direction of the stator, in one of the slots.

### INCORPORATION BY REFERENCE

The disclosure of Japanese Patent Application No. 2010-292776 filed on Dec. 28, 2010 including the specification, drawings and abstract is incorporated herein by reference in its entirety.

### BACKGROUND OF THE INVENTION

1. Field of the Invention

The invention relates to a superconducting electric motor and, more particularly, to a superconducting electric motor that includes a refrigerator having at least one narrow tube that flows low-temperature refrigerant inside.

2. Description of Related Art

In an existing art, a superconducting electric motor that includes a refrigerator is suggested. For example, Japanese Patent Application Publication No. 2010-178517 (JP-A-2010-178517) describes a superconducting electric motor apparatus that includes a superconducting electric motor, a cryogenic temperature generator and a casing. The superconducting electric motor includes a rotor and a stator. The rotor includes a rotatable rotary shaft and a plurality of permanent magnets arranged on the outer peripheral portion of the rotary shaft. The stator has three-phase superconducting coils that are wound around the teeth of a stator iron core. The cryogenic temperature generator has a refrigerator that generates cryogenic temperature at its cold head. There is provided a heat conductive portion having a high thermal conductivity. The heat conductive portion connects the cold head to the stator iron core of the stator of the superconducting electric motor so that heat is transferable. A cooling cylindrical portion of the heat conductive portion is cooled into a cryogenic condition, and is brought into thermal contact with the outer peripheral portion of the stator iron core to cool the stator iron core. The casing forms a vacuum insulation chamber that thermally insulates the superconducting coils. Therefore, even when heat is transferred to the superconducting coils or even when refrigeration output from the refrigerator does not catch up, the stator iron core keeps the superconducting coils in a low-temperature condition. In addition, FIG. 3 of JP-A-2010-178517 shows that a heat conductive material having a high thermal conductivity is provided between each of the teeth of the stator iron core and a corresponding one of the superconducting coils, and FIG. 4 of JP-A-2010-178517 shows that a heat conductive material is connected via a connecting portion to the heat conductive portion that surrounds the outer peripheral portion of the stator iron core. With the above configuration, the superconducting coils may possibly be cooled via the teeth cooled by the cryogenic temperature generator.

In addition, the pamphlet of International Publication No. WO/2003/001127A1 describes a cool storage refrigerator. The cool storage refrigerator includes pressure control means, an expansion/compression unit and a cool storage unit. The pressure control means have a compressor, a high-pressure selector valve and a low-pressure selector valve. The expansion/compression unit has a room-temperature end portion and a low-temperature end portion. The cool storage unit has a room-temperature end portion and a low-temperature end portion. The cool storage refrigerator transfers heat to a target to be cooled. The cool storage refrigerator couples the low-temperature end portion of the expansion/compression unit to the low-temperature end portion of the cool storage unit, and has a passage of working gas, extending to the target to be cooled. In addition, a pulse tube refrigerator generally serves an important role as cooling means for cooling sensors and semiconductor devices.

As in the case of the superconducting electric motor described in JP-A-2010-178517, in an existing art, cold is transferred by various methods when the superconducting coils are cooled; however, when the solid heat conductive materials are used to cool the superconducting coils, the thermal conductivity of each heat conductive material is finite, so, when heat is transferred through the heat conductive materials having a finite length, there occurs a temperature difference proportional to the amount of heat transferred and, therefore, it is difficult to improve cooling efficiency. For this reason, there is room for improvement in terms of improving the cooing efficiency of the superconducting coils to early cool the superconducting coils to thereby early generate a stable superconducting condition. In addition, when the superconducting electric motor is started, it is desired to early cool the superconducting coils while suppressing power consumption. In contrast to this, it has also been considered that a heat conductive material is brought into contact with the outer peripheral surface opposite to the superconducting coils, or the like, of a stator core to cool the superconducting coils by the heat conductive material via the stator core. However, in this case, the thermal capacity of the stator core is large, so it may take a long period of time until the superconducting coils are sufficiently cooled when the superconducting electric motor is started. In addition, power consumption tends to increase because of power for cooling the stator core. Therefore, it is desired to provide means for early cooling the superconducting coils at the time of starting the superconducting electric motor while suppressing power consumption to reduce a period of time that elapses until the superconducting coils reach a superconducting condition.

The pamphlet of International Publication No. WO/2003/001127A1 merely describes a cool storage refrigerator, and does not describe that the refrigerator is used to cool the superconducting coils of the superconducting electric motor.

### SUMMARY OF THE INVENTION

The invention efficiently cools superconducting coils of a superconducting electric motor to a desired cryogenic temperature and early places the superconducting coils in a superconducting condition at the time of starting the superconducting electric motor.

An aspect of the invention provides a superconducting electric motor. The superconducting electric motor includes: a rotor that is rotatably arranged; a stator that is arranged in a radial direction of the rotor so as to face the rotor; a case in which the rotor and the stator are arranged; and a refrigerator that has at least one narrow tube that flows low-temperature refrigerant inside, wherein the stator includes a stator core and a plurality of superconducting coils formed of a superconducting wire material, the stator core has an annular back yoke, a plurality of teeth that radially protrude from one radial end portion of the back yoke and slots, each of which is provided between two of the teeth, adjacent in a circumferential direction of the stator, the plurality of superconducting coils are respectively wound around the teeth, and at least part of the at least one narrow tube is arranged between two of the plurality of superconducting coils, adjacent in the circumferential direction of the stator, in one of the slots, and is in thermal contact with at least any one of the two superconducting coils.

In the superconducting electric motor according to the aspect of the invention, an entire part of the at least one narrow tube, arranged in one of the slots, may be arranged between the two of the plurality of superconducting coils, adjacent in the circumferential direction of the stator.

In the superconducting electric motor according to the aspect of the invention, the at least one narrow tube may be only in contact with at least one of the two superconducting coils in one of the slots.

The superconducting electric motor according to the aspect of the invention may further include an insulator that is provided between each of the teeth and a corresponding one of the superconducting coils and that is formed in a shape that decreases heat transfer between the tooth and the corresponding one of the superconducting coils or formed of a material that decreases the heat transfer. The shape that decreases the heat transfer may be one of comb-tooth shape and a shape having a hole that extends through a center portion of the insulator in a thickness direction of the insulator. The material that decreases the heat transfer may be glass-fiber reinforced resin (GFRP).

In the superconducting electric motor according to the aspect of the invention, the at least one narrow tube each may have a meandering portion that is arranged between two of the plurality of superconducting coils, adjacent in the circumferential direction of the stator, in one of the slots and that is in thermal contact with both the two adjacent superconducting coils.

In the superconducting electric motor according to the aspect of the invention, the plurality of superconducting coils each may have two coil end portions that respectively protrude axially outward from both axial end surfaces of the stator core, and the at least one narrow tube may have a coil end facing portion that is arranged so as to face an axially outer end surface portion of at least one of the two coil end portions and that is in contact with the at least one of the two coil end portions.

With the superconducting electric motor according to the aspect of the invention, at least part of the at least one narrow tube that is provided for the refrigerator and that flows low-temperature refrigerant inside is arranged between two of the plurality of superconducting coils, adjacent in the circumferential direction of the stator, in one of the slots, so the at least one narrow tube may be brought into direct contact with the two adjacent superconducting coils in one of the slots, and the two adjacent superconducting coils may be efficiently cooled to a desired cryogenic temperature. In addition, the two adjacent superconducting coils are cooled by the at least one narrow tube without intervening the stator core having a large thermal capacity, so the two adjacent superconducting coils are early cooled at the time of starting the superconducting electric motor while suppressing power consumption to thereby make it possible to reduce a period of time that elapses until the superconducting coils are placed in a superconducting condition. As a result, the superconducting coils may be efficiently cooled to a desired cryogenic temperature, and the superconducting coils may be early placed in a superconducting condition at the time of starting the superconducting electric motor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an axially cross-sectional view that shows a superconducting electric motor according to a first embodiment of the invention;

FIG. 2 is an enlarged cross-sectional view that is taken along the line II-II in FIG. 1;

FIG. 3 is a view that shows the basic configuration of a refrigerator used in the first embodiment in a state where all narrow tubes extend linearly;

FIG. 4 is a cross-sectional view that is taken along the line IV-IV in FIG. 3;

FIG. 5 is an axially cross-sectional view that shows a superconducting electric motor according to a comparative embodiment that departs from the aspect of the invention;

FIG. 6 is a cross-sectional view that is taken along the line VI-VI in FIG. 5;

FIG. 7 is a view that shows a superconducting electric motor according to a second embodiment of the invention and that corresponds to an enlarged cross-sectional view of a portion of the superconducting electric motor in the circumferential direction, taken along the line VII-VII in FIG. 1;

FIG. 8 is a view that shows a portion of a first example of an insulator in the circumferential direction, used in the second embodiment;

FIG. 9 is a view that shows a portion of a second example of an insulator in the circumferential direction, used in the second embodiment;

FIG. 10 is a view that shows a superconducting electric motor according to a third embodiment of the invention and that corresponds to an enlarged cross-sectional view of a portion of the superconducting electric motor in the circumferential direction, taken along the line II-II in FIG. 1;

FIG. 11 is a cross-sectional view that is taken along the line XI-XI in FIG. 10;

FIG. 12 is a view that shows a superconducting electric motor according to a fourth embodiment of the invention and that corresponds to an enlarged cross-sectional view of a portion of the superconducting electric motor in the circumferential direction, taken along the line II-II in FIG. 1;

FIG. 13 is an axially cross-sectional view that shows a superconducting electric motor according to a fifth embodiment of the invention;

FIG. 14 is an axially cross-sectional view that shows a superconducting electric motor according to a sixth embodiment of the invention; and

FIG. 15 is a cross-sectional view that is taken along the line XV-XV in FIG. 14.

### DETAILED DESCRIPTION OF EMBODIMENTS

### First Embodiment

Hereinafter, an embodiment of the invention will be described in detail with reference to the accompanying drawings. In this description, specific shapes, materials, numeric values, directions, and the like, are only illustrative for easily understanding the aspect of the invention and may be modified appropriately to meet an application purpose, an object, specifications, and the like.

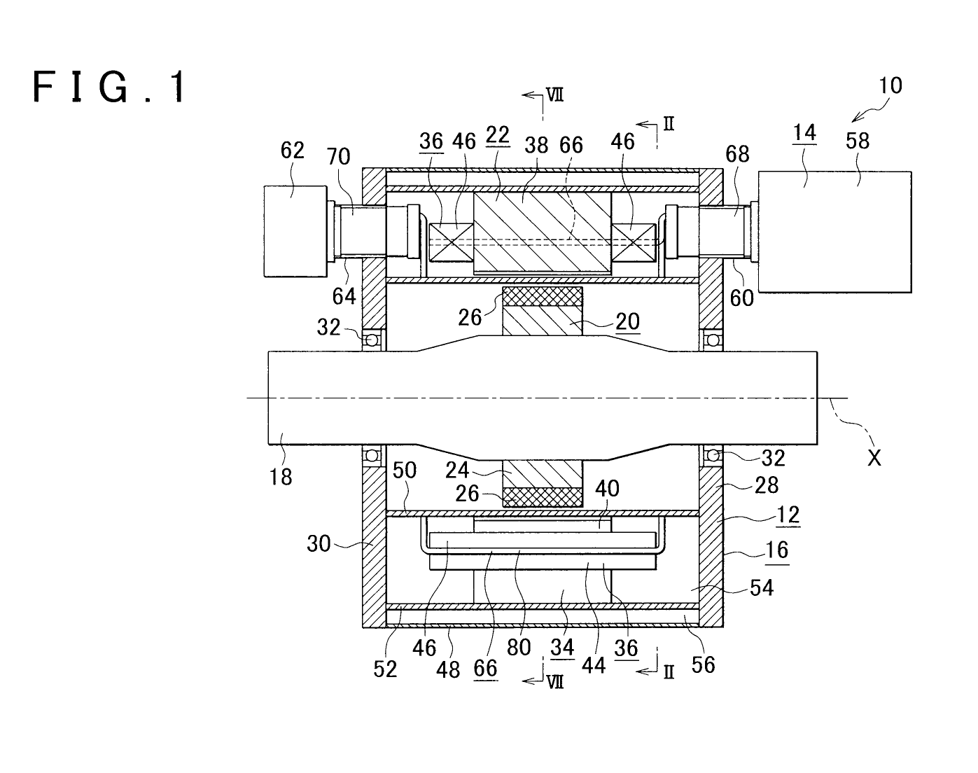

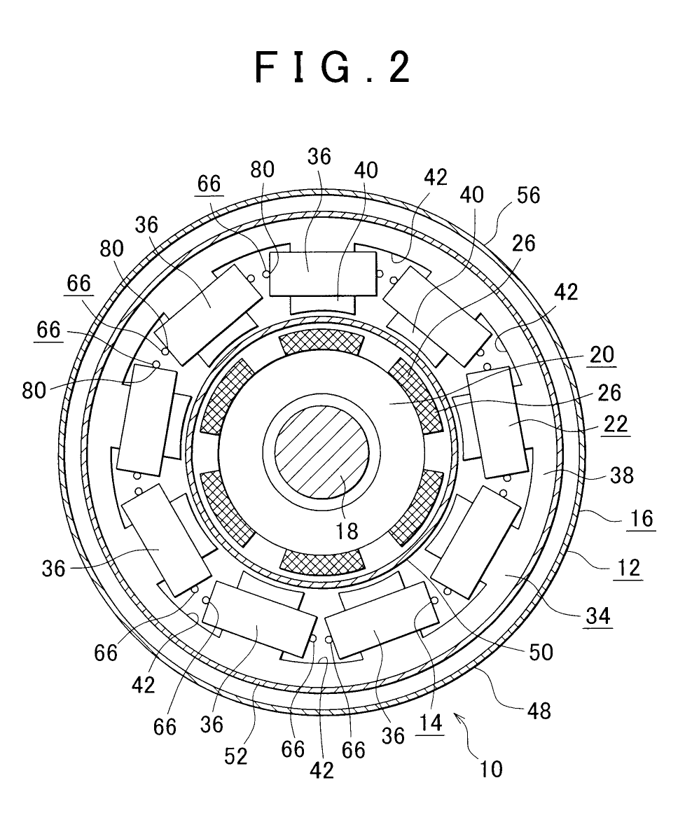

FIG. 1 to FIG. 4 show a superconducting electric motor according to a first embodiment of the invention. As shown in FIG. 1 and FIG. 2, the superconducting electric motor 10 includes a motor body 12 and a refrigerator 14. The refrigerator 14 is used to cool the motor body 12. The motor body 12 includes a motor case 16, a rotary shaft 18 and a rotor 20. The rotary shaft 18 is rotatably supported by the motor case 16. The rotor 20 is fixed to the outer side of the rotary shaft 18 inside the motor case 16 and is rotatably arranged. In addition, the motor body 12 includes a substantially cylindrical stator 22. The stator 22 is fixed to the inner peripheral surface of the motor case 16, and is arranged on the radially outer side of the rotor 20 so as to face the rotor 20. In addition, the refrigerator 14 is fixed to the motor case 16. Note that, in the following description, unless otherwise specified, a direction along the rotation central axis X of the rotary shaft 18 is termed axial direction, a radial direction perpendicular to the rotation central axis X is termed radial direction, and a direction along a circle about the rotation central axis X is termed circumferential direction.

The rotor 20 includes a cylindrical rotor core 24 and a plurality of permanent magnets 26. The rotor core 24 is, for example, formed so that flat rolled magnetic steel sheets are laminated and integrated by crimping, welding, or the like. The permanent magnets 26 are provided at equal intervals on the outer peripheral surface of the rotor core 24. That is, the plurality of (six in the example shown in FIG. 2) permanent magnets 26 are fixed to the outer peripheral surface of the rotor core 24 at equal intervals in the circumferential direction so that the permanent magnets 26 are exposed. The permanent magnets 26 are magnetized in the radial direction, and the magnetized directions of the permanent magnets 26 are alternately varied in the circumferential direction. Therefore, north poles and south poles are alternately arranged on the outer peripheral surface of the rotor 20. However, the permanent magnets 26 of the rotor 20 may not be exposed on the outer peripheral surface, and may be embedded inside near the outer peripheral surface. The thus configured rotor 20 is fixed to the outer peripheral surface of the rotary shaft 18 made of round bar steel material, or the like.

The rotary shaft 18 is rotatably supported by bearings 32 at its both end portions. The bearings 32 are respectively fixed to disc end plates 28 and 30. The end plates 28 and 30 respectively constitute both end portions of the motor case 16. By so doing, as a revolving magnetic field is generated in the stator 22, the rotor 20 receives the influence of the revolving magnetic field to rotate.

The stator 22 includes a stator core 34 and coils 36. The stator core 34 has a substantially cylindrical shape and serves as a stator iron core. The coils 36 serve as superconducting coils. That is, the stator core 34 has an annular back yoke 38 and a plurality of (nine in the example shown in FIG. 2) teeth 40. The teeth 40 are provided at multiple positions of an inner peripheral end portion at equal intervals in the circumferential direction so as to protrude in the radial direction. The inner peripheral end portion is one radial end portion of the back yoke 38. In addition, the stator core 34 has a plurality of (nine in the example of the drawing) slots 42 that are provided at multiple positions at equal intervals in the circumferential direction. Each of the slots 42 is provided between two of the teeth 40, adjacent in the circumferential direction, at the inner peripheral portion of the back yoke 38. The stator core 34 may be, for example, formed in such a manner that a plurality of substantially annular flat rolled magnetic steel sheets are laminated in the axial direction and are integrally assembled by crimping, adhesion, welding, or the like. Instead, the stator core may be formed in such a manner that a plurality of split cores each having one tooth are arranged continuously in an annular shape and fastened by a cylindrical fastening member from the outer side. The split cores may be formed of dust core.

The plurality of coils 36 formed of a superconducting wire material are respectively wound around the plurality of teeth 40 of the stator core 34 by concentrated winding. Note that the plurality of coils 36 may be respectively wound around the teeth 40 by distributed winding. In addition, the superconducting wire material may have a circular cross-sectional shape or a rectangular cross-sectional shape. For example, the coils 36 may be formed in such a manner that a superconducting wire material that is a flat wire having a rectangular cross-sectional shape is wound in a flatwise manner. For example, the coils 36 may be formed in such a manner that a superconducting wire material is wound around each of the teeth 40 by solenoidal winding or pancake winding. In addition, the superconducting wire material may be suitably, for example, an yttrium series superconducting material or a bismuth series superconducting material. However, the superconducting material that constitutes the superconducting wire material is not limited to these materials; it may be another known superconducting material or a superconducting material that will be developed in the future and that exhibits a superconducting property at a higher temperature.

The superconducting wire material that constitutes each coil 36 may be covered with insulating coating. By so doing, when the superconducting wire material is wound so as to be in closely contact with one another to form each coil 36, electrical insulation is ensured among the turns of each coil 36. Instead, when the superconducting wire material is not covered with insulating coating, the superconducting wire material may be wound into a coil shape while placing insulating paper, insulating film, or the like, in between at the time of forming each coil 36 to thereby ensure electrical insulation among the turns of each coil 36.

Each coil 36 has in-slot portions 44 and two coil end portions 46. The in-slot portions 44 are respectively located in corresponding two of the plurality of slots 42 (FIG. 2) provided at multiple positions of the stator core 34. The two coil end portions 46 respectively protrude axially outward from both axial end surfaces of the stator core 34. Three of the coils 36, which place two coils 36 in between, are connected in series with one another to constitute any one of U, V and W phase coils. One ends of the phase coils are connected to one another at a neutral point (not shown), and the other ends of the phase coils are respectively connected to phase current introducing terminals (not shown).

In addition, the motor case 16 accommodates the rotor 20 and the stator 22. The motor case 16 has a cylindrical outer peripheral cylindrical portion 48 and the pair of end plates 28 and 30. The outer peripheral edge portions of the pair of end plates 28 and 30 are respectively airtightly connected to both axial end portions of the outer peripheral cylindrical portion 48. The outer peripheral cylindrical portion 48 and the end plates 28 and 30 are, for example, formed of a non-magnetic material, such as stainless steel. Note that the outer peripheral cylindrical portion 48 and the one-side end plate 28 (or 30) may be formed of one piece member.

An inner cylindrical member 50 and an intermediate cylindrical member 52 are provided inside the outer peripheral cylindrical portion 48 concentrically with the rotor 20. The inner cylindrical member 50 and the intermediate cylindrical member 52 each have a cylindrical shape. Both axial end portions of each of the inner cylindrical member 50 and intermediate cylindrical member 52 are respectively airtightly coupled to the inner surfaces of the end plates 28 and 30. The inner cylindrical member 50 is desirably formed of a non-metal material (for example, FRP, or the like) that does not interfere with passage of a magnetic field and that is electrically not conductive. More desirably, the inner cylindrical member 50 is formed of a material having a low thermal conductivity. Note that the inner cylindrical member 50 just needs to have the function of passing a magnetic field and the function of being able to retain vacuum at a space sealing portion, including the inner cylindrical member 50, as basic functions, and is not limited to the one using an electrically non-conductive material. For example, a non-magnetic material having a low electrical conductivity (for example, stainless steel, or the like) may also be used as the material that constitutes the inner cylindrical member 50. On the other hand, the intermediate cylindrical member 52 is desirably formed of a material having a low thermal conductivity (for example, FRP, or the like), and is more desirably formed of a non-magnetic material having a low thermal conductivity.

The inner cylindrical member 50 has an inside diameter that is slightly larger than the diameter of the outermost circumcircle of the rotor 20. A gap is formed between the inner cylindrical member 50 and the outer peripheral surface of the rotor 20.

In addition, a first vacuum chamber 54 is provided between the inner cylindrical member 50 and the intermediate cylindrical member 52. The first vacuum chamber 54 is a cylindrical space. The stator 22 that includes the coils 36 are accommodated in the first vacuum chamber 54. The outer peripheral surface of the stator core 34 that constitutes the stator 22 is fixed to the inner peripheral surface of the intermediate cylindrical member 52.

The first vacuum chamber 54 is maintained in a vacuum condition in such a manner that, after the superconducting electric motor 10, including the refrigerator 14 described in detail later, is assembled, air is evacuated through an air vent hole (not shown) formed in at least any one of members, such as the end plates 28 and 30 and the outer peripheral cylindrical portion 48, that adjoin an external space and one or both of the first vacuum chamber 54 and a second vacuum chamber 56. In this way, the first vacuum chamber 54 is defined by the inner cylindrical member 50, which is not in contact with the coils 36 and the stator 22, and the intermediate cylindrical member 52 having a low thermal conductivity, and the inside of the first vacuum chamber 54 is evacuated. By so doing, it is possible to enhance heat insulation to the stator 22, including the coils 36, accommodated in the first vacuum chamber 54.

Furthermore, the second vacuum chamber 56 is formed between the intermediate cylindrical member 52 and the motor case 16. The second vacuum chamber 56 is formed of a cylindrical space. The second vacuum chamber 56, as well as the first vacuum chamber 54, is in a vacuum condition. A hole that provides fluid communication between the first vacuum chamber 54 and the second vacuum chamber 56 is desirably provided for the intermediate cylindrical member 52. By so doing, the stator 22, which includes the coils 36 and which is accommodated in the first vacuum chamber 54, is isolated from the outside of the motor additionally by the second vacuum chamber 56. Thus, it is possible to further enhance heat insulation effect to the stator 22 including the coils 36.

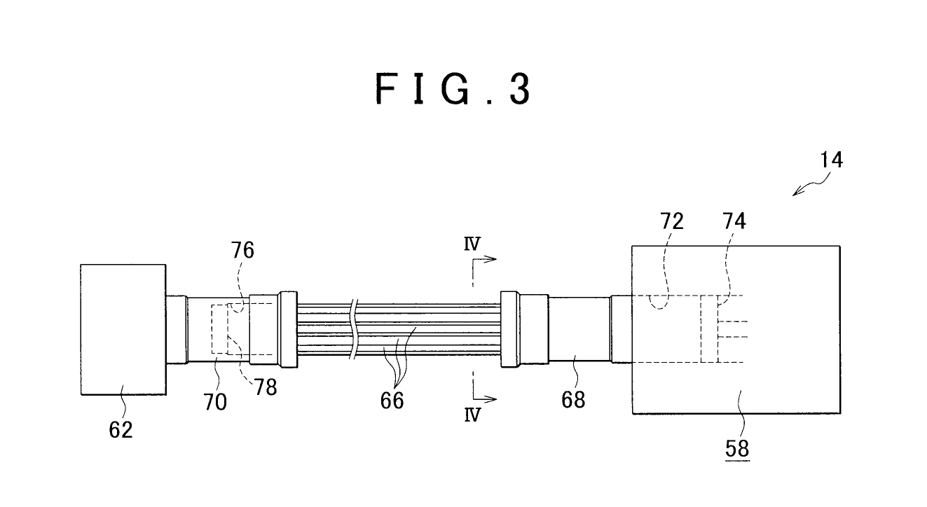

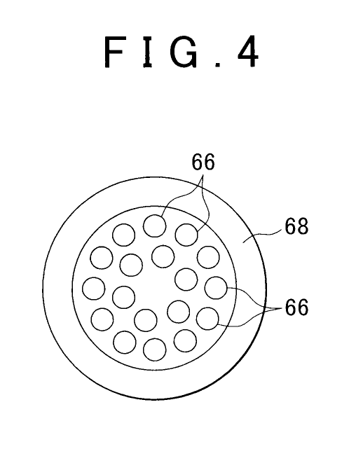

In addition, the refrigerator 14 is fixed to the motor body 12 that constitutes the superconducting electric motor 10. Next, the basic configuration of the refrigerator 14 will be described with reference to FIG. 3 and FIG. 4. FIG. 3 is a view that shows the basic configuration of the refrigerator 14 used in the present embodiment in a state where all narrow tubes 66 extend linearly. FIG. 4 is a cross-sectional view that is taken along the line IV-IV in FIG. 3. The refrigerator 14 is a free-piston Stirling cooler (FPSC). The refrigerator 14 has the plurality of narrow tubes 66 that are used to flow refrigerant gas. That is, the refrigerator 14 includes a pressure vibration source 58, a cool storage device 68, a phase controller 62, a second piston accommodating portion 70 and the plurality of narrow tubes 66. The pressure vibration source 58 is provided at one end of the refrigerator 14, and serves as a refrigerator drive source. The cool storage device 68 is called cold head, and one end portion of the cool storage device 68 is fixed to the pressure vibration source 58. The phase controller 62 is provided at the other end of the refrigerator 14. One end portion of the second piston accommodating portion 70 is fixed to the phase controller 62. The plurality of narrow tubes 66 are connected between the cool storage device 68 and the second piston accommodating portion 70. The plurality of narrow tubes 66 serve as a plurality of cooling portions, and are formed of a material having a high thermal conductivity. A cool storage medium (not shown) is provided inside the cool storage device 68. In addition, the outer sides of the cool storage device 68 and second piston accommodating portion 70 are covered with a heat insulation material, so that the cool storage device 68 and the second piston accommodating portion 70 have a heat insulation structure.

The refrigerator 14 has a first piston 74. The first piston 74 linearly reciprocates in the cylinder 72 of the pressure vibration source 58, and serves as a drive piston. The space in the cylinder 72 is in fluid communication with the insides of the plurality of narrow tubes 66 via the inside of the cool storage device 68. In addition, the refrigerator 14 also has a second piston 78. The second piston 78 linearly reciprocates in the cylinder 76 of the second piston accommodating portion 70, and is called an expansion piston or a driven piston. The space in the cylinder 76 is in fluid communication with the insides of the plurality of narrow tubes 66 that serve as a low-temperature-side heat exchanging portion. Refrigerant gas (for example, helium gas) is filled in the internal space between the first piston 74 and the second piston 78, including the plurality of narrow tubes 66. That is, the narrow tubes 66 each are configured to flow low-temperature refrigerant gas inside.

In addition, the pressure vibration source 58 and the second piston accommodating portion 70 are arranged so as to face each other such that the directions in which the pistons 74 and 78 move are along the same straight line. The first piston 74 is, for example, connected to a mover of a linear motor, or the like, (not shown) that constitutes the pressure vibration source 58, and the linear motor is used to reciprocate the first piston 74 inside the cylinder 72. With the reciprocation of the first piston 74, the pressure of refrigerant gas varies within the cylinder 72 of the pressure vibration source 58. Owing to the pressure variation, the second piston 78 that is suspended by a spring formed of a coil spring, a leaf spring, or the like, (not shown) inside the phase controller 62 also dependently reciprocates. A phase difference between a pressure variation and a positional variation in refrigerant gas may be adjusted by the weight of the spring (not shown), the weight of the second piston 78 and a pressure variation resulting from the reciprocation of the first piston 74. In addition, a space that relieves a pressure variation resulting from the reciprocation of the second piston 78 is provided inside the phase controller 62. By so doing, the space is in fluid communication with the inside of the cylinder 76, in which the second piston 78 is arranged, to thereby make it possible to adjust the phase difference between the pressure variation and positional variation of refrigerant gas.

With the reciprocation of the first piston 74, refrigerant gas adiabatically expands and is cooled at a portion of the second piston accommodating portion 70 near the end portions of the narrow tubes 66, so refrigerant gas flowing through the insides of the narrow tubes 66 is also cooled. In this way, compression and expansion of refrigerant gas are repeated between the first piston 74 and the second piston 78 to cool the narrow tubes 66 through which refrigerant gas flows.

The refrigerator 14 has cooling performance such that the coils 36 made of a superconducting wire material may be cooled to a desired cryogenic temperature (for ex ample, about 70K) at which the coils 36 exhibit a superconducting property. The cooling temperature of the refrigerator 14 may be adjusted by controlling the stroke of the first piston 74. Therefore, the stroke of the first piston 74 is controlled by a control unit (not shown). The control unit may be configured to control the cooling temperature of the refrigerator 14 according to a load of the superconducting electric motor 10 (FIG. 1). For example, the cooling temperature may be decreased with an increase in the load of the superconducting electric motor 10. When the superconducting electric motor 10 is mounted on an electromotive vehicle, such as an electric vehicle, as a driving source for propelling the vehicle, the refrigerator 14 is desirably smaller and lighter because of a limited installation space and a reduction in vehicle weight. When the FPSC is used as the refrigerator 14 as described above, the refrigerator 14 may be reduced in size and weight.

In the present embodiment, the refrigerator 14 having such a basic configuration is fixed to the motor body 12 (FIG. 1). That is, as shown in FIG. 1, in the superconducting electric motor 10, a cylindrical first bracket 60 adjacent to the pressure vibration source 58 that constitutes the refrigerator 14 is fixed to the end plate 28 located at one axial end, and a cylindrical second bracket 64 adjacent to the phase controller 62 that constitutes the refrigerator 14 is fixed to the end plate 30 located at the other axial end. Then, the pressure vibration source 58 and the second piston accommodating portion 70 are arranged along the same straight line parallel to the rotation axis X of the rotary shaft 18, and are arranged on both axial sides of the motor body 12. In addition, one end portion of the cool storage device 68 and one end portion of the second piston accommodating portion 70 respectively protrude into the first vacuum chamber 54 via the inside of the first bracket 60 and the inside of the second bracket 64.

In addition, as shown in FIG. 2, the longitudinal center portions of the plurality of narrow tubes 66, which serve as the low-temperature-side heat exchanging portion, are arranged two by two in each of the slots 42 that constitute the stator core 34. That is, each narrow tube 66 has a linear straight portion 80 that extends parallel to the rotation axis X of the rotary shaft 18. At least part of linear straight portion 80 is arranged in a corresponding one of the slots 42. In the example of the drawing, the straight portions 80 of the two narrow tubes 66 are arranged in each of the slots 42. At least part of each straight portion 80 is arranged in a corresponding one of the slots 42 between two of the coils 36, adjacent in the circumferential direction of the stator 22. In the example of the drawing, the entire portion of each straight portion 80, arranged in the corresponding slot 42, is arranged between two of the coils 36, adjacent in the circumferential direction of the stator 22.

In addition, the two straight portions 80 arranged in each slot 42 are arranged apart from each other in the circumferential direction. The circumferential one-side straight portion 80 is in contact with the outer peripheral portion of the circumferential one-side coil 36 in the slot 42, and the circumferential other-side straight portion 80 is in contact with the outer peripheral portion of the circumferential other-side coil 36 in the slot 42. Each of the straight portions 80 is not in contact with the back yoke 38 of the stator core 34. That is, each narrow tube 66 is only in contact with one coil 36 in a corresponding one of the slots 42. Therefore, cold is transferred from each narrow tube 66 to a corresponding one of the coils 36 via the contact portion with the narrow tube 66. In this way, each of the plurality of narrow tubes 66 is configured such that the center portion is arranged in a corresponding one of the slots 42, so a part or whole of the plurality of narrow tubes 66 are formed so that the center portion is bent into a substantially crank shape, or the like.

With the above configuration, the narrow tubes 66 of which the number is twice the number of the slots 42 of the stator core 34 are provided. That is, the low-temperature-side heat exchanging portion is formed of the narrow tubes 66 of at least the same number as the number of the slots 42 of the stator core 34. In addition, each of the plurality of narrow tubes 66 is arranged parallel to the rotary shaft 18 in a corresponding one of the slots 42, and is in contact with a corresponding one of the coils 36 so as to cool the coil 36.

With the above configuration, a high-temperature-side heat exchanging portion is formed of an end portion of the second piston accommodating portion 70, arranged outside of the motor case 16. The above refrigerator 14 includes the pressure vibration source 58, the high-temperature-side heat exchanging portion, the cool storage device 68, the low-temperature-side heat exchanging portion and the second piston 78 (FIG. 3).

With the above superconducting electric motor 10, at least part of each of the narrow tubes 66 that constitute the refrigerator 14 and that flow low-temperature refrigerant gas inside is arranged in a corresponding one of the slots 42 between two of the coils 36 of the stator 22, adjacent in the circumferential direction, and is in contact with and in thermal contact with at least any one of the two adjacent coils 36. Therefore, the narrow tubes 66 may be brought into direct contact with the corresponding coils 36 in the slots 42, so the coils 36 may be efficiently cooled to a desired cryogenic temperature. In addition, the coils 36 are cooled by the narrow tubes 66 without intervening the stator core 34 having a large thermal capacity, so the coils 36 are early cooled at the time of starting the superconducting electric motor 10 while suppressing power consumption to thereby make it possible to reduce a period of time that elapses until the coils 36 are placed in a superconducting condition. As a result, the coils 36 may be efficiently cooled to a desired cryogenic temperature, and the coils 36 may be early placed in a superconducting condition at the time of starting the superconducting electric motor 10.

In addition, each narrow tube 66 has the straight portion 80 that is an extended portion extending parallel to the axial direction of the stator 22 in a corresponding one of the slots 42, and each straight portion 80 is only in contact with the coil 36 in a corresponding one of the slots 42. In this way, the straight portions 80 do not contact with the stator core 34 via the back yoke 38, or the like, so cold may be further efficiently transferred from the narrow tubes 66 to the coils 36 to further early cool the coils 36 at the time of starting the superconducting electric motor 10. In addition, generally, a superconducting coil has an extremely poor heat conductivity as compared with a copper wire that constitutes the coil of an electric motor used at normal room temperatures, so it is difficult to uniformly cool the superconducting coil. In contrast to this, according to the above configured present embodiment, for example, in the coils 36, different from the case of a configuration that only the coil end portions 46 are cooled, the in-slot portions 44 of the coils 36 may be efficiently cooled, so the whole of the coils 36, which serve as superconducting coils, are easily cooled further uniformly. That is, the coils 36 may be cooled while reducing a biased temperature distribution among the whole of the coils 36.

Note that each narrow tube 66 has only one straight portion 80 that extends in the axial direction and that is provided in a corresponding one of the slots 42 in the above description. However, the present embodiment is not limited to such a configuration. It is also applicable that each narrow tube has two or more straight portions arranged in a corresponding one of the slots 42. In addition, it is also applicable that each narrow tube has a substantially U-shaped portion that is fitted between two of the coils 36, adjacent in the circumferential direction, in a corresponding one of the slots 42 and the substantially U-shaped portion has straight portions that extend in the axial direction and that arc respectively in contact with the two adjacent coils 36 facing each other. In addition, the straight portions 80 of two of the narrow tubes 66 are arranged in each of the slots 42; instead, it is also applicable that only the straight portion 80 of one of the narrow tubes 66 is arranged in each of the slots 42 and the one straight portion 80 is only in contact with any one of two of the coils 36, adjacent in the circumferential direction (for example, only circumferential one-side coil 36) in the slot 42. In this case as well, one narrow tube 66 is in contact with each of the coils 36, so the coils 36 may be efficiently cooled.

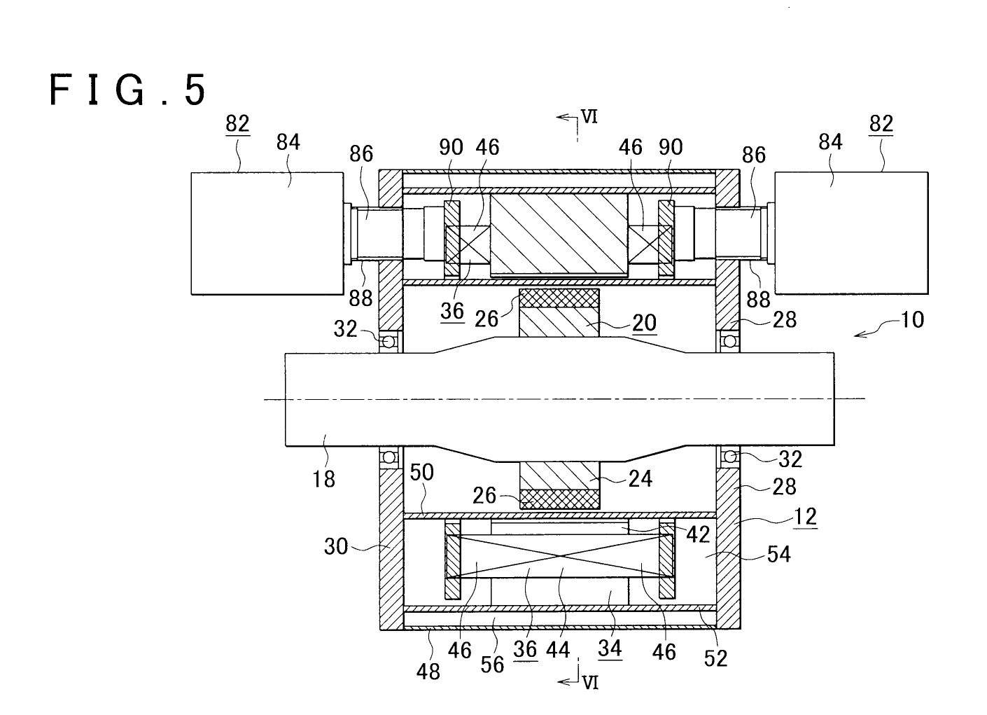

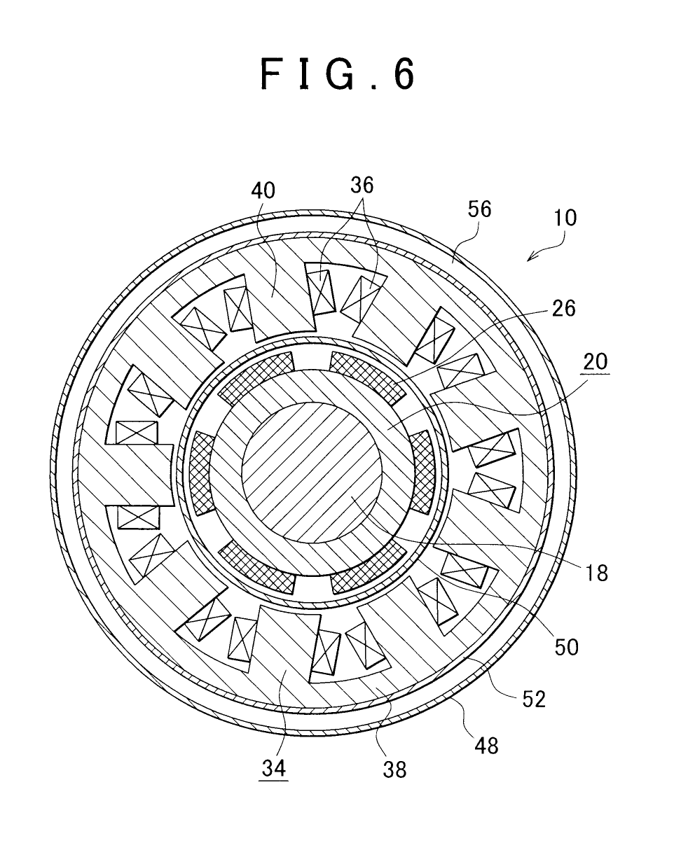

FIG. 5 is an axially cross-sectional view that shows a superconducting electric motor according to a comparative embodiment that departs from the aspect of the invention. FIG. 6 is a cross-sectional view that is taken along the line VI-VI in FIG. 5. The superconducting electric motor 10 according to the comparative embodiment shown in FIG. 5 and FIG. 6 differs from that of the structure of the present embodiment in that a pair of refrigerators 82 are provided on both sides of the motor body 12 instead of the refrigerator 14 (FIG. 1, and the like). That is, different from the refrigerator 14, each refrigerator 82 is an FPSC with no narrow tube that is used to flow refrigerant, and includes a gas compressor 84 that serves as a pressure vibration source and a cool storage device 86 that serves as a cooling portion connected to the gas compressor 84. In addition, the distal end portion of each cool storage device 86 is in contact with a disc-shaped heat transfer member 90 through the inside of a cylindrical bracket 88 fixed to the end plate 28 or 30. One-side surface of each heat transfer member 90 is in contact with the axially outer end portions of the coil end portions 46.

Each refrigerator 82 cools the coils 36 via the cool storage device 86 and the heat transfer member 90 in such a manner that a piston (not shown) reciprocates in a cylinder (not shown) provided inside the gas compressor 84 to repeatedly compress and expand refrigerant gas. With the above configuration as well, the coils 36 may be cooled; however, there is room for improvement in terms of easily cooling the whole of the coils 36 uniformly. In addition, each heat transfer member 90 transfers heat to a target to be cooled only using solid matter, which is different from the configuration that the narrow tubes that flow refrigerant inside are used, so there is room for improvement in terms of cooling the plurality of coils 36 uniformly. According to the above present embodiment, any of these points that should be improved may be improved.

Note that, in the above description, the refrigerator 14 is a passive refrigerator in which the second piston 78 is dependently displaced with a displacement of the first piston 74. However, a refrigerator may be provided with a second driving source, such as a linear motor, that forcibly displaces the second piston 78 at the side of the phase controller 62 so that, when the first piston 74 is reciprocally displaced, the second piston 78 is displaced at a phase shifted about 90 to 120 degrees from the phase of a cycle of the reciprocal displacement of the first piston 74. In this case, an active refrigerator is configured, and further energy saving may be achieved.

In addition, a refrigerator, other than an FPSC, may be used as the refrigerator 14. For example, when there is a small limitation on the installation space and weight of a refrigerator, such as when the superconducting electric motor 10 is used as a power source for a large-sized mobile unit, such as an electric train and a ship, or when a power source for a machine of which the installation site is fixed, a large and heavy refrigerator may be used as long as the refrigerator has a plurality of narrow tubes and has cooling performance such that a target to be cooled may be cooled to a cryogenic temperature (for example, about 70K).

In addition, a Stirling pulse tube refrigerator, a GM refrigerator, or the like, each having narrow tubes, may be used as the refrigerator. For example, in the pulse tube refrigerator, instead of the second piston accommodating portion 70, a pulse tube connected between the narrow tubes 66 and the phase controller 62 is used. No piston is provided inside the pulse tube. In the pulse tube refrigerator, the structure of vibrating pressure by opening and closing a valve may be used as the pressure vibration source 58. In addition, for the GM refrigerator, a rotary compressor or the structure of vibrating pressure by opening and closing a valve may be used in the FPSC refrigerator as the pressure vibration source 58. In addition, in this structure, the phase controller 62 is omitted and a displacer that serves as an expansion piston is reciprocally displaceably provided for the expansion/compression unit connected to the end portions of the narrow tubes 66, which are opposite to the pressure vibration source 58. The displacer is, for example, reciprocated by a motor, such as a stepping motor, during operation of the refrigerator. In this way, according to the aspect of the invention, various types of refrigerators may be used as the refrigerator as long as the refrigerators have narrow tubes that flow refrigerant inside.

### Second Embodiment

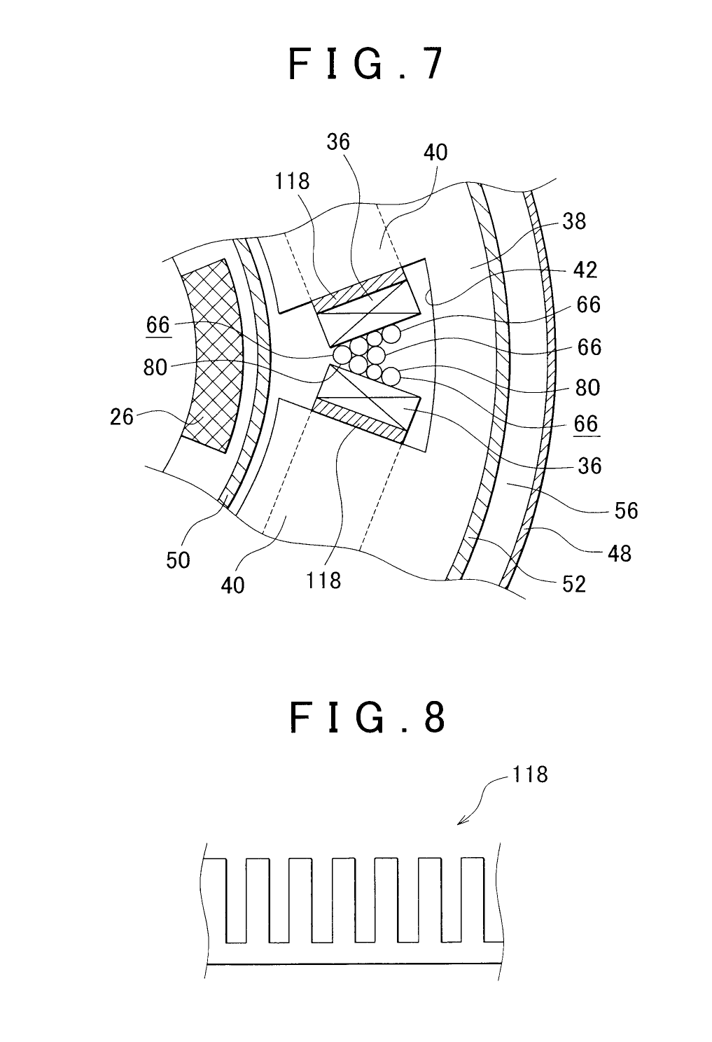

FIG. 7 is a view that shows a superconducting electric motor according to a second embodiment of the invention and that corresponds to an enlarged cross-sectional view of a portion of the superconducting electric motor in the circumferential direction, taken along the line VII-VII in FIG. 1.

The superconducting electric motor 10 according to the present embodiment differs from the first embodiment in that the number of the plurality of narrow tubes 66 is increased and three or more (eight in the example of the drawing) straight portions 80 of the narrow tubes 66 are arranged between the two coils 36 in each of the slots 42. Then, the straight portions 80 that constitute the respective narrow tubes 66 are arranged so as to be pushed into between the two coils 36. In this state, among the plurality of straight portions 80 arranged in each slot 42, part of the straight portions 80 are in direct contact with the coils 36, and the remaining straight portion 80 is in contact with the coils 36 via the other straight portions 80 so as to be in thermal contact with the coils 36. Note that the “thermal contact” in this specification includes not only direct contact between members that mutually transfer heat but also contact via a member having a thermal conductivity. In addition, the straight portion 80 of each narrow tube 66 is not in contact with the back yoke 38.

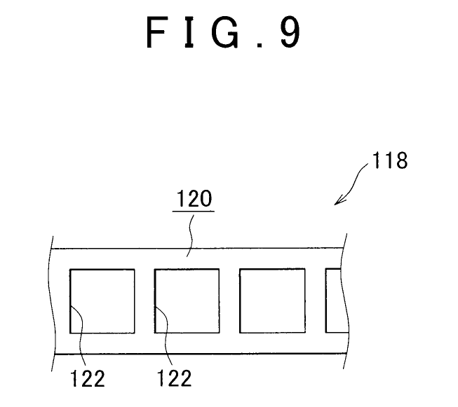

In addition, an insulator 118 having an electrical insulation property is provided around each of the teeth 40. The insulators 118 are also provided in the first embodiment; however, in the present embodiment, each insulator 118 is formed of one or both of a shape that decrease heat transfer between the tooth 40 and a corresponding one of the coils 36 and a material that decreases the heat transfer. For example, FIG. 8 and FIG. 9 show two examples of the shape that decreases the heat transfer. FIG. 8 is a view that shows a portion of a first example of the insulator in the circumferential direction, used in the second embodiment. In the case of the first example shown in FIG. 8, the insulator 118 has a comb-tooth shape over all around the insulator 118. The insulator 118 is, for example, made of resin. Each coil 36 (FIG. 7) is brought into contact with the corresponding tooth 40 (FIG. 7) via the insulator 118 to thereby ensure electrical insulation between the tooth 40 and the coil 36 and reduce the contact area between the tooth 40 and the insulator 118 and the contact area between the coil 36 and the insulator 118 to thereby reduce the amount of heat transferred from the teeth 40 to the coils 36 as compared with the case where an existing insulator that is formed so that a thin film is simply coupled annularly over all around is used.

In addition, FIG. 9 is a view that shows a portion of a second example of the insulator in the circumferential direction, used in the second embodiment. In the case of the second example shown in FIG. 9, the insulator 118 has a plurality of holes 122 that are provided at multiple positions of an annular portion 120 in the circumferential direction and that extend through in the thickness direction. The annular portion 120 is formed by coupling a thin film annularly. The insulator 118 shown in FIG. 9 is also, for example, made of resin. Each coil 36 is brought into contact with the corresponding tooth 40 via the insulator 118 to thereby ensure electrical insulation between the tooth 40 and the coil 36 and reduce the contact area between the tooth 40 and the insulator 118 and the contact area between the coil 36 and the insulator 118 to thereby reduce the amount of heat transferred from the teeth 40 to the coils 36 as compared with the case where an existing insulator that is formed so that a thin film is simply coupled annularly over all around is used.

In addition, the insulator 118, as well as the existing insulator, may have an annular structure such that a thin film is coupled annularly, and may be formed of, for example, glass-fiber reinforced resin (GFRP) as a material that decreases heat transfer. In this way, each insulator 118 provided between the coil 36 and the tooth 40 is formed in a shape that decreases heat transfer or formed of a material that decreases heat transfer to reduce the amount of heat transferred from the teeth 40 to the coils 36 via the insulators 118. By so doing, cold is further efficiently transferred from the narrow tubes 66 to the coils 36 to thereby make it possible to early cool the coils 36. In addition, in each of the slots 42, the number of narrow tubes 66 arranged between the two coils 36 is increased as compared with that of the first embodiment, so it is possible to further improve cooling performance for cooling the coils 36. The other configuration and function are the same as those of the first embodiment. Note that the shape of each insulator 118 is not limited to the configurations shown in FIG. 8 and FIG. 9; instead, the insulator 118 may be formed similarly to that of the existing insulator that is formed so that a thin film is simply coupled annularly over all around but the thickness of the insulator 118 may be increased as compared with the existing insulator. With the above configuration, it is possible to reduce the amount of heat transferred between the coils 36 and the teeth 40. Note that the configuration that each insulator 118 formed in a shape that decreases heat transfer or formed of a material that decreases heat transfer is arranged between the tooth 40 and the coil 36 as described above may be combined with any one of the above first embodiment and embodiments described later.

### Third Embodiment

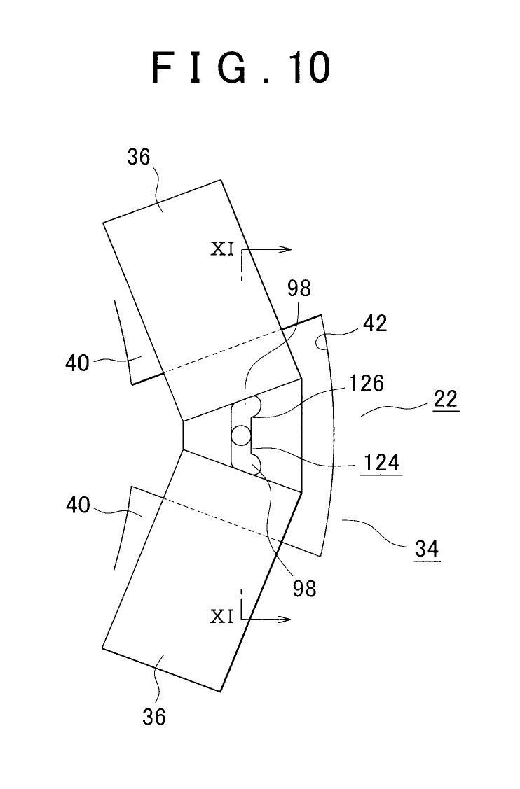

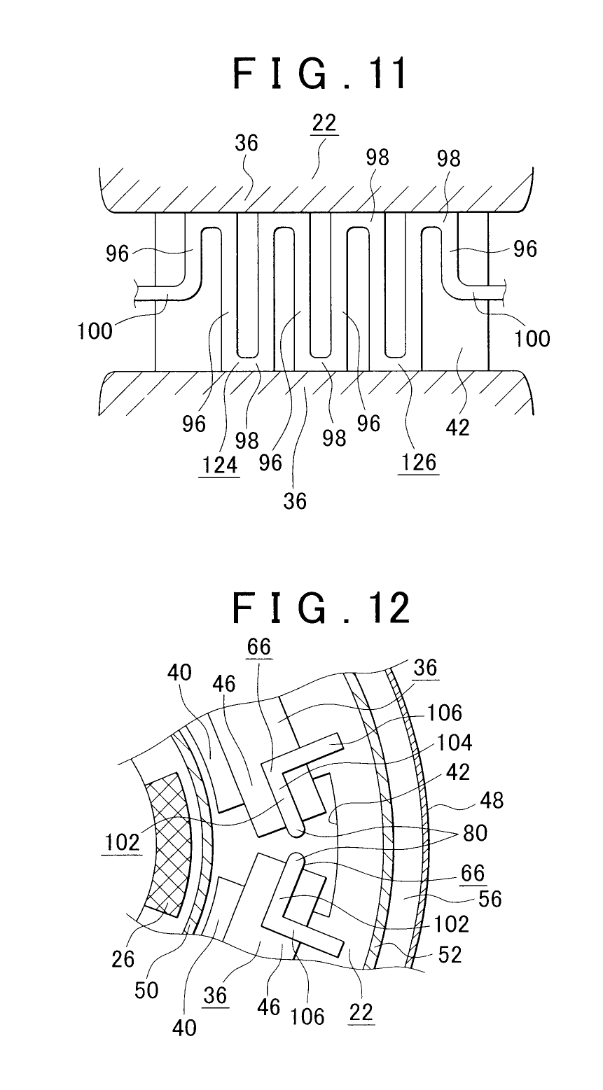

FIG. 10 is a view that shows a superconducting electric motor according to a third embodiment of the invention and that corresponds to an enlarged cross-sectional view of a portion of the superconducting electric motor in the circumferential direction, taken along the line II-II in FIG. 1. FIG. 11 is a cross-sectional view that is taken along the line XI-XI in FIG. 10. In the case of the present embodiment, each narrow tube 124 does not have a straight portion extending over the entire length of the slot 42 in the axial direction in a corresponding one of the slots 42. Instead, in the present embodiment, each of the plurality of narrow tubes 124 has a meandering portion 126 having a meander shape at its center portion arranged in a corresponding one of the slots 42. The meandering portion 126 is an extended portion extending in the axial direction of the stator 22 (front-back direction of FIG. 10). As shown in FIG. 11, each meandering portion 126 flows refrigerant gas inside, and has a plurality of circumferential portions 96 and coupling portions 98. The plurality of circumferential portions 96 extend in the circumferential direction of the stator 22 (vertical direction in FIG. 11). The coupling portions 98 each couple the end portions of the adjacent circumferential portions 96. Each meandering portion 126 extends in the axial direction of the stator 22 (horizontal direction in FIG. 11) as a whole. Each coupling portion 98 may be formed in a substantially U shape. In addition, as shown in FIG. 10, a part (for example, only the longitudinal center portion of each coupling portion 98) or whole of each coupling portion 98 has a bent portion that is bent in a direction along the side surface of any one of the facing coils 36. For example, it may be configured so that refrigerant gas flowed through the circumferential portion 96 once flows along the side surface of the coil 36 at the bent portion of the coupling portion 98 and then flows into the adjacent circumferential portion 96. Therefore, the contact area between the meandering portions 126 and the coils 36 may be increased, and thermal contact performance may be improved. In addition, in each meandering portion 126, straight portions 100 that extend in the axial direction of the stator 22 are respectively coupled to the end portions of the circumferential portions 96 located at both axial ends of the slot 42. Between the two straight portions 100, one end of one of the straight portions 100 is connected to the cool storage device 68 (FIG. 1), and one end of the other one of the straight portions 100 is connected to the second piston accommodating portion 70 (FIG. 1).

As shown in FIG. 10, the meandering portion 126 arranged in each slot 42 is arranged so as to be interposed between two of the coils 36, adjacent in the circumferential direction, and is only in contact with and only in thermal contact with both outer peripheral edge portions of the adjacent two coils 36. The meandering portion 126 is not in contact with the stator core 34 at the bottom, or the like, of the slot 42. In this way, each of the narrow tubes 124 includes the meandering portion 126 that is arranged between two of the coils 36, adjacent in the circumferential direction of the stator 22, in a corresponding one of the slots 42 and that is provided for each of the narrow tubes 124 so as to be in thermal contact with both the adjacent two coils 36.

With the above configuration, because each narrow tube 124 includes the meandering portion 126 that is arranged in the slot 42, part of each narrow tube 124 is just provided in the corresponding slot 42 to thereby make it possible to bring the narrow tube 124 into contact with both the two coils 36 adjacent in the circumferential direction and to further efficiently cool the coils 36. The other configuration and function are the same as those of the first embodiment shown in FIG. 1 to FIG. 4.

### Fourth Embodiment

FIG. 12 is a view that shows a superconducting electric motor according to a fourth embodiment of the invention and that corresponds to an enlarged cross-sectional view of a portion of the superconducting electric motor in the circumferential direction, taken along the line II-II in FIG. 1. The present embodiment differs from the first embodiment shown in FIG. 1 to FIG. 4 in that each narrow tube 66 having the straight portion 80 arranged in a corresponding one of the slots 42 has coil end facing portions 102 at portions that protrude outward from the slot 42. The coil end facing portions 102 are arranged so as to face the axially outer end surface portions of the coil end portions 46. In the example shown in the drawing, each coil end facing portion 102 has a circumferential portion 104 and a radial portion 106. The circumferential portion 104 is coupled to one of both axial end portions of the straight portion 80 of the narrow tube 66 and extends in the circumferential direction of the stator 22 along the axially outer end surface portion of the coil end portion 46. The radial portion 106 is coupled to the circumferential portion 104 at the end portion adjacent to the circumferential center of the corresponding tooth 40 and extends radially outward of the stator 22. Then, at least part of the circumferential portion 104 and at least part of the radial portion 106 are brought into contact with and into thermal contact with the axially outer side surface portion of the coil end portion 46. That is, each narrow tube 66 is arranged so as to be in contact with the axially outer end surface portions of the pair of coil end portions 46. With the above configuration, cooling performance for cooling the coils 36 may be further improved, and the whole of the coils 36 may be easily cooled further uniformly. That is, the coils 36 may be cooled while reducing a biased temperature distribution among the whole of the coils 36.

Note that it may be configured such that each narrow tube may be only brought into contact with the axially outer end portion of one of the pair of coil end portions 46. The other configuration and function are the same as those of the first embodiment shown in FIG. 1 to FIG. 4. Note that the structure of a portion that brings each narrow tube 66 into contact with the axially outer side surface portions of the coil end portions 46 is not limited to the structure having the illustrated shape; instead, various structures may be employed. In addition, the structure that each narrow tube has the coil end facing portions that are arranged so as to face the axially outer end surface portions of the coil end portions 46 as described above may be applied to any one of the second and third embodiments shown in FIG. 7 to FIG. 11 and embodiments described later.

### Fifth Embodiment

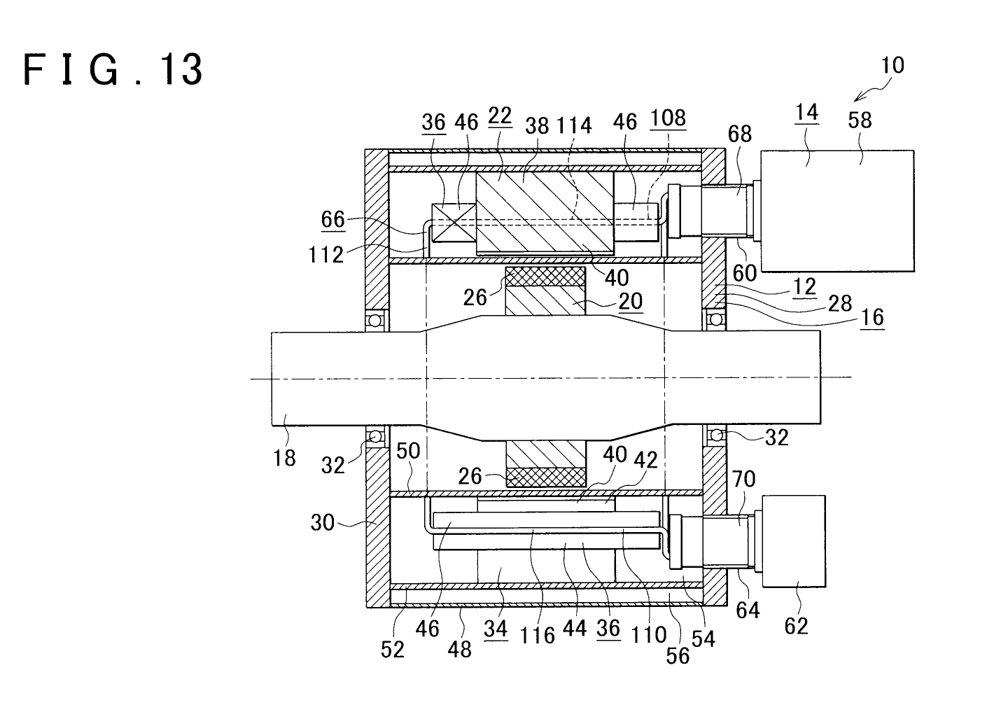

FIG. 13 is an axially cross-sectional view that shows a superconducting electric motor according to a fifth embodiment of the invention. The superconducting electric motor 10 according to the present embodiment differs from that of the first embodiment shown in FIG. 1 to FIG. 4 in that the numbers of the slots 42 and teeth 40, which constitute the stator core 34, are even number, such as twelve. In addition, the pressure vibration source 58 and the second piston accommodating portion 70 are provided at only one of the pair of end plates 28 and 30 at mutually different positions in the circumferential direction, such as positions at opposite sides in the diametrical direction. That is, the first bracket 60 adjacent to the pressure vibration source 58 is fixed to a portion of the one-side end plate 28 in the circumferential direction, and a second bracket 64 adjacent to the phase controller 62 is fixed to the opposite side of the one-side end plate 28 in the diametrical direction of the rotary shaft 18 with respect to the pressure vibration source 58. That is, the pressure vibration source 58 and the second piston accommodating portion 70 are provided only at one axial side of the motor body 12.

In addition, each narrow tube 66 has a one-side portion 108, an other-side portion 110 and a coupling portion 112. One end of the one-side portion 108 is connected to the cool storage device 68. One end of the other-side portion 110 is connected to the second piston accommodating portion 70. The coupling portion 112 couples the one-side portion 108 to the other-side portion 110 so as to provide fluid communication between the inside of the one-side portion 108 and the inside of the other-side portion 110. The one-side portion 108 has a first straight portion 114 that passes in the axial direction through one of the slots in the circumferential direction.

The other-side portion 110 has a second straight portion 116 that passes in the axial direction through the slot 42 opposite in substantially the diametrical direction of the stator 22 with respect to the one of the slots in the circumferential direction. The straight portions 114 and 116 each are arranged between two of the coils 36, adjacent in the circumferential direction, in a corresponding one of the slots 42 and each are in contact with at least one of the adjacent two coils 36.

In this way, the aspect of the invention may be implemented by the structure that the pressure vibration source 58 and the second piston accommodating portion 70 are arranged at one axial side of the motor body 12. The other configuration and function are the same as those of the first embodiment shown in FIG. 1 to FIG. 4. Note that, the structure that the pressure vibration source 58 and the second piston accommodating portion 70 are arranged at one axial side of the motor body 12 as described above may be applied to any one of the second to fourth embodiments shown in FIG. 7 to FIG. 12.

### Sixth Embodiment

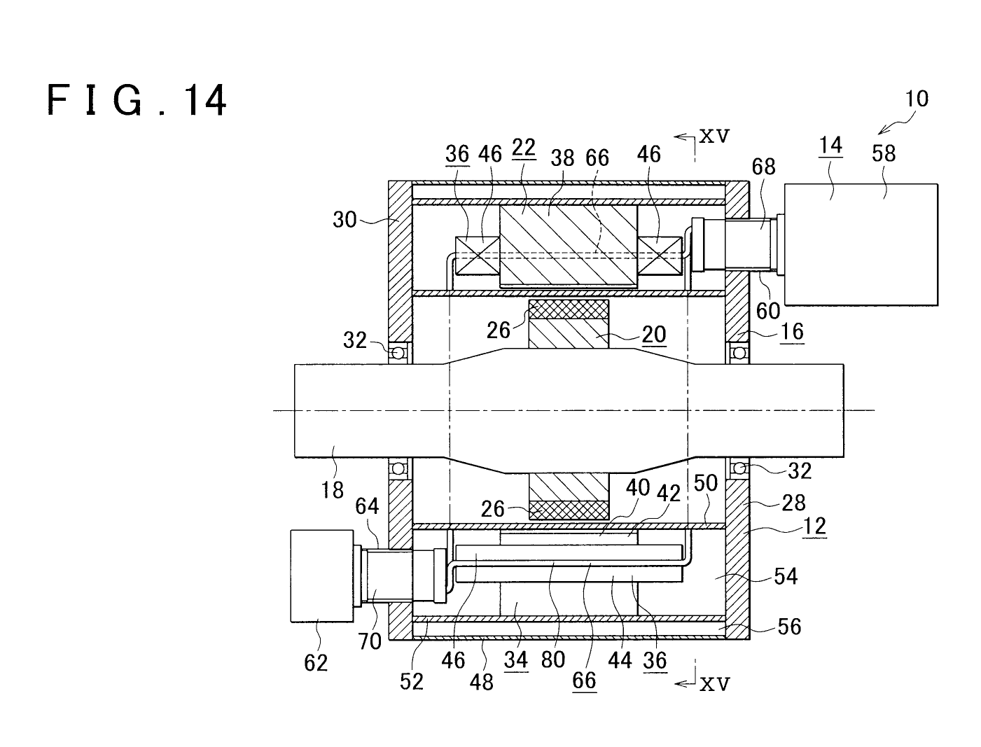

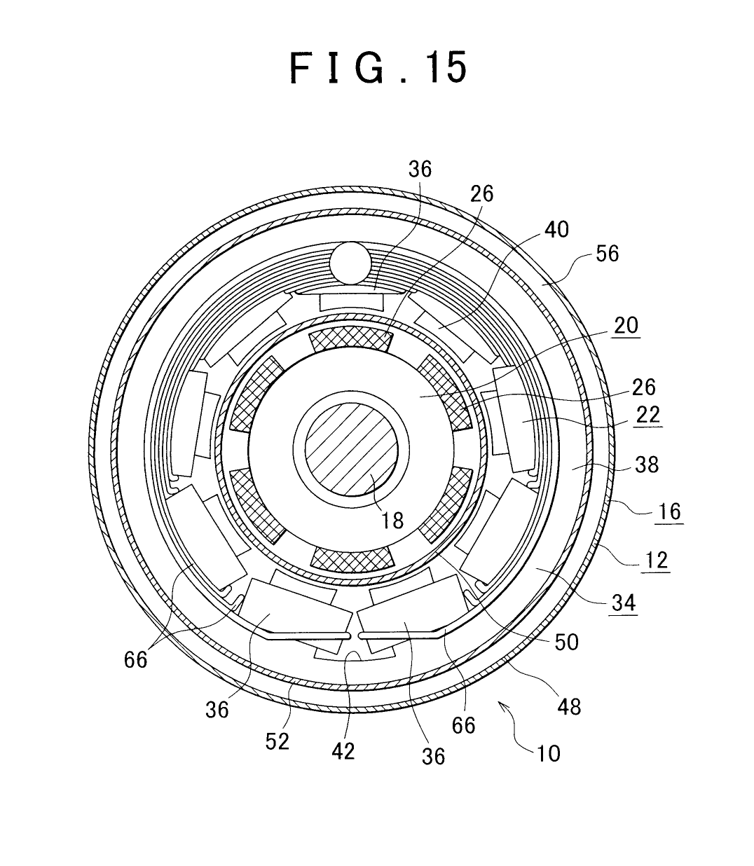

FIG. 14 is an axially cross-sectional view that shows a superconducting electric motor according to a sixth embodiment of the invention. FIG. 15 is a cross-sectional view that is taken along the line XV-XV in FIG. 14. The superconducting electric motor 10 according to the present embodiment differs from that of the first embodiment shown in FIG. 1 to FIG. 4 in that the pressure vibration source 58 and the second piston accommodating portion 70 are respectively provided on the outer sides of the pair of end plates 28 and 30 at mutually different positions in the circumferential direction, such as positions at opposite sides in the diametrical direction. That is, the first bracket 60 adjacent to the pressure vibration source 58 is fixed to a portion of the one-side end plate 28 in the circumferential direction, and the second bracket 64 adjacent to the phase controller 62 is fixed to a portion of the other-side end plate 30 at the opposite side in the diametrical direction of the rotary shaft 18 with respect to the pressure vibration source 58. In this way, the pressure vibration source 58 and the second piston accommodating portion 70 are provided respectively at both axial sides of the motor body 12.

In addition, as in the case of the first embodiment, each narrow tube 66 has the straight portion 80 that is arranged between two of the coils 36, adjacent in the circumferential direction, in a corresponding one of the slots 42 and that is in contact with any one of the two coil 36 adjacent in the circumferential direction. In addition, part of each narrow tube 66 may be brought to face the axially outer end surface portion of at least one coil end portion 46 and may be brought into contact with the axially outer end surface portion. In the case of the above configuration, different from the first embodiment, the plurality of narrow tubes 66 may have a substantially equal length or may be brought close to the same length. That is, the difference in length among the plurality of narrow tubes 66 may be eliminated or reduced. Therefore, the plurality of coils 36 may be cooled by the plurality of narrow tubes 66 to a substantially uniform temperature or so as to be brought close to a further uniform temperature. Furthermore, according to the present embodiment, the plurality of narrow tubes 66 may have a substantially equal length or may be brought close to the same length, so refrigeration performance may be improved. That is, the performance of the refrigerator 14 requires that pressure variations in the low-temperature portion heat exchanger and the piston arrangement spaces and positional variations in refrigerant gas serving as working gas are maintained at appropriate phase angles. If it is assumed that a variation in phase angle in one narrow tube, that is, a variation in phase angle that varies in one narrow tube, has been optimized, the variation in phase angle for a narrow tube having another length deviates from an optimal value. Therefore, all the narrow tubes have substantially the same length to thereby make it possible to obtain a phase angle close to an optimal value in all the narrow tubes and to improve refrigeration performance. In the present embodiment, the plurality of narrow tubes 66 may have a substantially equal length or may be brought close to the same length, so refrigeration performance may be improved. The other configuration and function are the same as those of the first embodiment shown in FIG. 1 to FIG. 4. Note that the structure that the pressure vibration source 58 and the second piston accommodating portion 70 are arranged on both axial sides of the motor body 12 and arranged at opposite sides in the diametrical direction of the rotary shaft 18 as described above may be applied to any one of the second to fourth embodiments shown in FIG. 7 to FIG. 12.

Note that, in the above embodiments, the aspect of the invention is applied to the inner rotor structure in which the stator is arranged on the radially outer side of the rotor so as to face the rotor. However, the aspect of the invention is not limited to this configuration. The aspect of the invention may be applied to an outer rotor structure in which the stator is arranged on the radially inner side of the rotor so as to face the rotor. In this case, the superconducting coils are wound at an outer peripheral end portion that is one radial end portion of the stator core.

What is claimed is:

1. A superconducting electric motor comprising:
a rotor that is rotatably arranged;
a stator that is arranged in a radial direction of the rotor so as to face the rotor;
a case in which the rotor and the stator are arranged; and
a refrigerator that has at least one narrow tube that flows low-temperature refrigerant inside, wherein
the stator includes a stator core and a plurality of superconducting coils formed of a superconducting wire material,
the stator core has an annular back yoke, a plurality of teeth that radially protrude from one radial end portion of the back yoke and slots, each of which is provided between two of the teeth, adjacent in a circumferential direction of the stator,
the plurality of superconducting coils are respectively wound around the teeth, and
at least part of the at least one narrow tube is arranged between two of the plurality of superconducting coils, adjacent in the circumferential direction of the stator, in one of the slots, and is in thermal contact with at least any one of the two superconducting coils.

2. The superconducting electric motor according to claim 1, wherein
an entire part of the at least one narrow tube, arranged in one of the slots, is arranged between the two of the plurality of superconducting coils, adjacent in the circumferential direction of the stator.

3. The superconducting electric motor according to claim 1, wherein
the at least one narrow tube is only in contact with at least one of the two superconducting coils in one of the slots.

4. The superconducting electric motor according to claim 1, further comprising:
an insulator that is provided between each of the teeth and a corresponding one of the superconducting coils and that is formed in a shape that decreases heat transfer between the tooth and the corresponding one of the superconducting coils.

5. The superconducting electric motor according to claim 4, wherein
the shape that decreases heat transfer is one of a comb-tooth shape and a shape having a hole extending through a center portion of the insulator in a thickness direction of the insulator.

6. The superconducting electric motor according to claim 1, further comprising:
an insulator that is provided between each of the teeth and a corresponding one of the superconducting coils and that is formed of a material that decreases the heat transfer.

7. The superconducting electric motor according to claim 6, wherein
the material that decreases heat transfer is glass-fiber reinforced resin.

8. The superconducting electric motor according to claim 1, wherein
the at least one narrow tube each has a meandering portion that is arranged between two of the plurality of superconducting coils, adjacent in the circumferential direction of the stator, in one of the slots and that is in thermal contact with both the two adjacent superconducting coils.

9. The superconducting electric motor according to claim 1, wherein
the plurality of superconducting coils each has two coil end portions that respectively protrude axially outward from both axial end surfaces of the stator core, and
the at least one narrow tube has a coil end facing portion that is arranged so as to face an axially outer end surface portion of at least one of the two coil end portions and that is in contact with the at least one of the two coil end portions.

10. The superconducting electric motor according to claim 1, wherein
a low-temperature-side heat exchanging portion of the refrigerator is formed of the at least one narrow tube.

11. The superconducting electric motor according to claim 4, wherein
the insulator has an electrical insulation property.

12. The superconducting electric motor according to claim 6, wherein
the insulator has an electrical insulation property.
